(19) United States
(12) Patent Application Publication
(10) Pub. No.: US 2024/0323076 A1
(43) Pub. Date: Sep. 26, 2024

(54) STEM-LIKE NETWORK NODE

(71) Applicant: SOLUTIONS HUMANITAS INC., Montreal (CA)

(72) Inventors: Abdo SHABAH, Montreal (CA); Maroua BEN ATTIA, Montreal (CA); Chuan PHAM, Montreal (CA)

(21) Appl. No.: 18/392,842

(22) Filed: Dec. 21, 2023

Related U.S. Application Data
(60) Provisional application No. 63/436,483, filed on Dec. 30, 2022.

(51) Int. Cl. H04L 41/0803; H04W 24/02

(52) U.S. Cl. CPC H04L 41/0803; H04W 24/02

(57) ABSTRACT

A system, a network node and a method executed at the network node, in a network of devices, for providing one or more networking functionalities on the fly. A gap is identified in telecommunications service offering in the network of devices. It is then determined that the one or more networking functionalities, upon deployment, at least partly fill the identified gap; the one or more networking functionalities are deployed, at least temporarily, in the network; periodical assessment of the relevance of maintaining deployment of the one or more networking functionalities in the network is performed; and, upon determination that the one or more networking functionalities are superfluous, the one or more functionalities are decommissioned at least temporarily.

This non-provisional patent application claims priority based upon the prior U.S. provisional patent application entitled “STEM-LIKE NETWORK NODE”, application No. 63/436,483, filed 2022 Dec. 30, in the name of Solutions Humanitas Inc., which is hereby incorporated by reference in its entirety.

### TECHNICAL FIELD

The present invention relates to a versatile network node and, more particularly, to a versatile network node that can be deployed on the fly.

### BACKGROUND

Telecommunications networks are critical infrastructures on which societies rely for many essential services. Making these infrastructures more resilient to natural as well as man-made catastrophes is therefore highly valuable.

A solution that at least partly alleviates this problem is presented herein.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect hereof is direct to a method executed at a network node, in a network of devices, for providing one or more networking functionalities on the fly. The method comprises identifying a gap in telecommunications service offering in the network of devices; determining that the one or more networking functionalities, upon deployment, at least partly fill the identified gap; deploying, at least temporarily, the one or more networking functionalities in the network; periodically assessing relevance of maintaining deployment of the one or more networking functionalities in the network; and, upon determination that the one or more networking functionalities are superfluous, at least temporarily decommissioning the one or more functionalities.

Optionally, the method may further comprise negotiating the deployment with one or more of the devices therebefore. Identifying the gap may optionally be performed by receiving a request from one or more of the devices. Identifying the gap may optionally alternatively be performed by autonomously detecting deterioration of the telecommunication service offering at the network node. Periodically assessing may optionally be performed using a timer and wherein determination is made that the one or more networking functionalities are superfluous upon expiry of the timer.

A second aspect hereof is directed to a network node comprising one or more processors. The one or more processors are configured to identify a gap in telecommunications service offering in the network of devices; determine that the one or more networking functionalities, upon deployment, at least partly fill the identified gap; deploy, at least temporarily, the one or more networking functionalities in the network; periodically assess relevance of maintaining deployment of the one or more networking functionalities in the network; and, upon determination that the one or more network functionalities are superfluous, at least temporarily decommission the one or more functionalities.

Optionally, the one or more processors may be configured to negotiate the deployment with one or more of the devices therebefore. Optionally, identifying the gap may be performed by the one or more processors being configured to receive a request from one or more of the devices. Optionally, and alternatively, identifying the gap may be performed by the one or more processors being configured to autonomously detect deterioration of the telecommunication service offering at the network node. Periodically assessing may optimally be performed by the one or more processors being configured to using a timer and wherein determination is made that the one or more networking functionalities are superfluous upon expiry of the timer.

A third aspect hereof is directed to a system comprising a network and a plurality of devices in the network. One or more of the devices comprise one or more processors configured to identify a gap in telecommunications service offering in the network of devices, determine that the one or more networking functionalities, upon deployment, at least partly fill the identified gap; deploy, at least temporarily, the one or more networking functionalities in the network; periodically assess relevance of maintaining deployment of the one or more networking functionalities in the network; and, upon determination that the one or more network functionalities are superfluous, at least temporarily decommission the one or more functionalities.

Optionally, the one or more processors may be configured to negotiate the deployment with one or more of the devices therebefore. Optionally, identifying the gap may be performed by the one or more processors being configured to receive a request from one or more of the devices. Optionally, and alternatively, identifying the gap may be performed by the one or more processors being configured to autonomously detect deterioration of the telecommunication service offering at the network node. Periodically assessing may optimally be performed by the one or more processors being configured to using a timer and wherein determination is made that the one or more networking functionalities are superfluous upon expiry of the timer.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary network node deployed in a system in accordance with the teachings of the present invention;

FIG. 2 is a flow chart of an exemplary method in accordance with the teachings of the present invention;

FIG. 3 is a logical representation of an exemplary 5G network in accordance with the teachings of the present invention;

FIG. 4 is a flow chart of an exemplary control loop in accordance with the teachings of the present invention;

FIG. 5 is a logical representation chart of an logical layers in a stem cell node in accordance with the teachings of the present invention;

FIG. 6 is a logical representation chart of an IAB architecture in accordance with the teachings of the present invention

FIG. 7A and FIG. 7B, herein referred to concurrently as FIG. 7, are views of an exemplary use case of a deployment in accordance with the teachings of the present invention;

FIGS. 8A, FIG. 8B and FIG. 8C, herein referred to concurrently as FIG. 8, are views of an exemplary use case of a deployment in accordance with the teachings of the present invention;

FIG. 9A and FIG. 9B, herein referred to concurrently as FIG. 9, are views of an exemplary use case of a deployment in accordance with the teachings of the present invention;

FIG. 10A and FIG. 10B, herein referred to concurrently as FIG. 10, are views of an exemplary use case of a deployment in accordance with the teachings of the present invention;

FIG. 11A and FIG. 11B, herein referred to concurrently as FIG. 11, are views of an exemplary use case of a deployment in accordance with the teachings of the present invention;

FIG. 12A and FIG. 12B, herein referred to concurrently as FIG. 12, are views of an exemplary use case of a deployment in accordance with the teachings of the present invention;

FIG. 13A and FIG. 13B, herein referred to concurrently as FIG. 13, are views of an exemplary use case of a deployment in accordance with the teachings of the present invention;

FIG. 14A and FIG. 14B, herein referred to concurrently as FIG. 14, are views of an exemplary use case of a deployment in accordance with the teachings of the present invention;

FIGS. 15A, FIG. 15B and FIG. 15C, herein referred to concurrently as FIG. 15, are views of an exemplary use case of a deployment in accordance with the teachings of the present invention;

FIG. 16A and FIG. 16B, herein referred to concurrently as FIG. 116 are views of an exemplary use case of a deployment in accordance with the teachings of the present invention;

FIG. 17A and FIG. 17B, herein referred to concurrently as FIG. 17, are views of an exemplary use case of a deployment in accordance with the teachings of the present invention.

### DETAILED DESCRIPTION

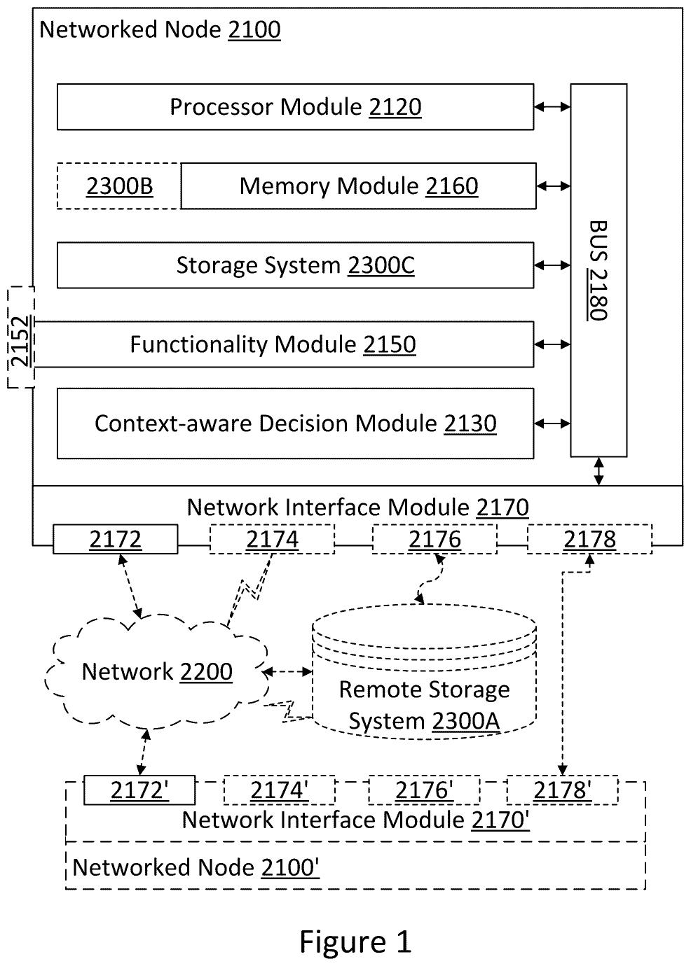

FIG. 1 shows a logical modular representation of an exemplary system 2000 comprising a network node 2100. The network node 2100 comprises a memory module 2160, a processor module 2120, a context-aware decision module 2130 module that may also comprise an optional sensing module and a network interface module 2170. The system 2000 may also include a storage system 2300. The system 2000 includes a network 2200 that may be used for accessing storage system 2300 or other nodes (not shown).

The network node 2100 may comprise a storage system 2300 for storing and accessing long-term (i.e., non-transitory) data and may further log data while the innovation accelerator system is being used. FIG. 1 shows examples of the storage system 2300 as a distinct database system 2300A, a distinct module 2300C of the innovation accelerator system 2100 or a sub-module 2300B of the memory module 2160 of the innovation accelerator system 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the innovation accelerator system 2100 by a standardized or proprietary interface or via the network interface module 2170. The variants of storage system 2300 usable in the context of the present invention will be readily apparent to persons skilled in the art.

In the depicted example of FIG. 1, the distributed network node 2100 shows an optional remote storage system 2300A which may communicate through the network 2200 with the network node 2100. The storage system 2300, (e.g., a networked data storage system) accessible to all modules of the network node 2100 via the network interface module 2170 through a network 2200, may be used to store data. The storage system 2300 may represent one or more logical or physical as well as local or remote hard disk drive (HDD) (or an array thereof). The storage system 2300 may further represent a local 2300B, 2300C or remote database 2300A made accessible to the network node 2100 by a standardized or proprietary interface. The network interface module 2170 represents at least one physical interface that can be used to communicate with other network nodes. The network interface module 2170 may be made visible to the other modules of the network node 2100 through one or more logical interfaces. The actual stacks of protocols used by the physical network interface(s) and/or logical network interface(s) of the network interface module 2170 do not affect the teachings of the present invention. The variants of processor module 2120, memory module 2160, network interface module 2170 and storage system 2300 usable in the context of the present invention will be readily apparent to persons skilled in the art.

Likewise, even though explicit mentions of the memory module 2160 and/or the processor module 2120 are not made throughout the description of the present examples, persons skilled in the art will readily recognize that such modules are used in conjunction with other modules of the network node 2100 to perform routine as well as innovative steps related to the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.). The network interface module 2170 represents at least one physical interface that can be used to communicate with other network nodes. The network interface module 2170 may be made visible to the other modules of the innovation accelerator system 2100 through one or more logical interfaces. The actual stacks of protocols used by the physical network interface(s) and/or logical network interface(s) 2172-2178 of the network interface module 2170 do not affect the teachings of the present invention. The variants of processor module 2120, memory module 2160 and network interface module 2170 usable in the context of the present invention will be readily apparent to persons skilled in the art.

A bus 2180 is depicted as an example of means for exchanging data between the different modules of the network node 2100. The present invention is not affected by the way the different modules exchange information. For instance, the memory module 2160 and the processor module 2120 could be connected by a parallel bus, but could also be connected by a serial connection or involve an intermediate module (not shown) without affecting the teachings of the present invention.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

The context-aware decision module 2130 provides network functionality selection and related services to the network node 2100, which will be described in more details hereinbelow.

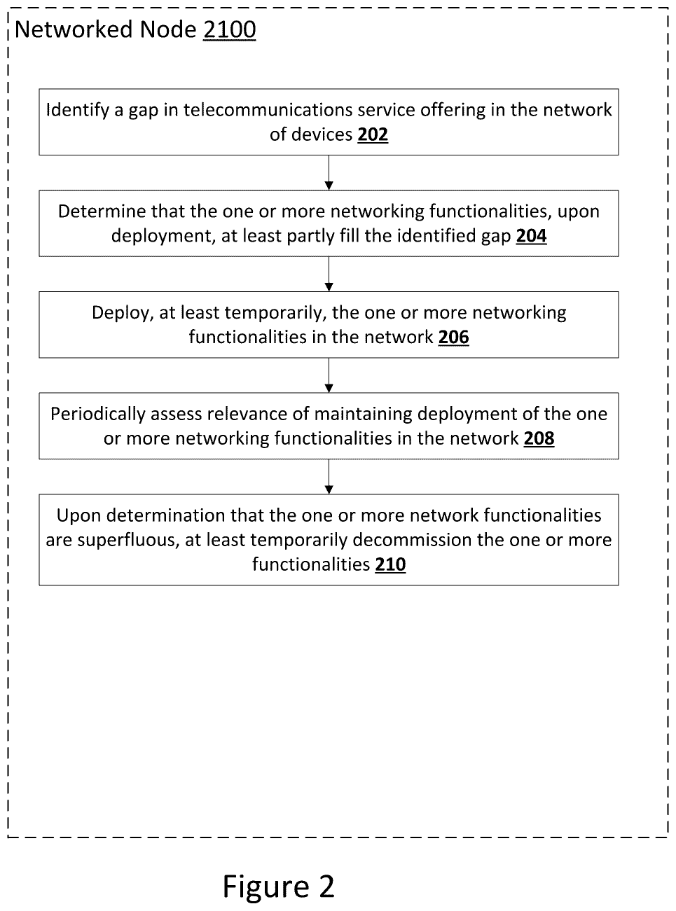

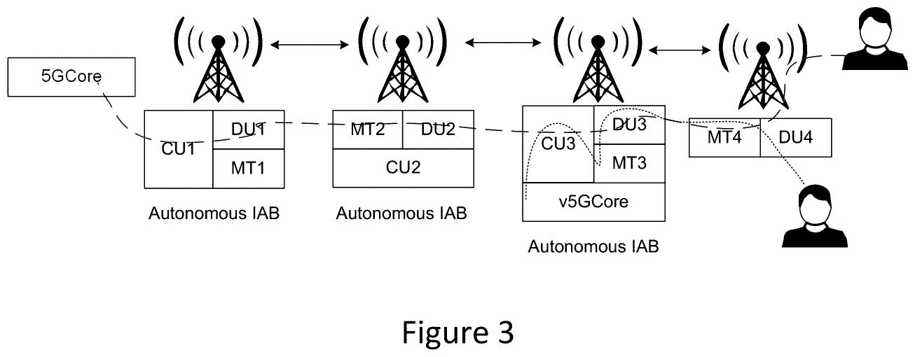

As will become apparent with particular reference to FIG. 2 and FIG. 3, a functionality module 2150 of the network node 2100 provides one or more networking functionalities that can be selectively activated and/or deactivated from the context-aware decision module 2130. The networking functionalities of the network node 2100 requires resources from the processor module 2120 and the memory module 2160 and may rely on dedicated interfaces 2152 and/or on the network interface module 2170. The one or more networking functionalities may always run or, in certain embodiments, may be triggered by an event detected at or by the context-aware decision module 2130. For instance, an event that may trigger one or more networking functionalities is a status determination of a neighboring node (e.g., failure, overload, service-level agreement (SLA) not respected, Quality of Service (QoS) degradation, . . . ) made by the context-aware decision module 2130.

A status determination may be made by the context-aware decision module 2130 when determining changes in the environment detected, e.g., using a sensing module (not shown) of the context-aware decision module 2130.

A change in the environment may be detected by the sensing module when triggering some behaviors from the signals of the networking nodes. The sensing module may include, as an example, sensing through the communication interface of neighboring nodes, or sense environmental changes based on perturbations of the signals.

A status determination may be made by the context-aware decision module 2130 when determining new geo-positioning of networking nodes detected by the sensing module.

A change in the geo-positioning of networking nodes may be detected by the sensing module wherein periodically assessing may be performed using an indoor and/or outdoor positioning system and/or algorithm and which requires resources from the processor module 2120 and the memory module 2160 and may rely on dedicated interfaces 2152 and/or on the network interface module 2170.

A status determination may be made by the context-aware decision module 2130 when entering or exiting a GPS-defined area, connecting or disconnecting from the network 2200 or another network (not shown), explicitly activating the one or more networking functionalities of the network node 2100 (e.g., physical switch or logical switch (not shown) activated (not shown) locally or remotely from the network node 2100, etc.). Another example of an event detected by the context-aware decision module 2130 may be a request to join a cluster or external resources, such as a data center, received from the network interface module 2170. Other exemplary events may include detecting presence or absence of a device in the surrounding of the network node 2100 (e.g., detecting presence of any kind of electromagnetic emissions, detecting absence of a specific kind of electromagnetic emissions and/or identifying presence or absence of a specific device, etc.) or physical changes in the environment (such CSI-based detection).

A network node 2100′ is depicted on FIG. 1 to illustrate an example of devices that may be part of the network 2000 and participate to provision of telecommunications services in the network 2000. Skilled persons will readily understand that the network node 2100′ is presented as an example and that typical telecommunications network comprise multiple network nodes having various responsibilities (e.g., radio access, radio access network (RAN) provisioning and management functions, code network provisioning and management functions, . . . ). The network node 2100 may therefore activate, in a context-aware manner, one or more networking functionalities to complement, supplement and/or replace telecommunications services provided (e.g., currently and/or previously) by the network node 2100′ and/or provide one or more networking functionalities that are similar to the telecommunications services of the network node 2100′. Likewise, the network node 2100 may therefore deactivate, in a context-aware manner, one or more networking functionalities that complemented, supplemented and/or replaced telecommunications services provided (e.g., currently and/or in the near future) by the network node 2100′ and/or stop provisioning of one or more networking functionalities that are similar to the telecommunications services of the network node 2100′.

FIG. 2 is a flowchart of an exemplary method 200 performed by the network node 2100 for providing one or more networking functionalities on the fly. As shown in FIG. 2, the method 200 comprises identifying 202 a gap in telecommunications service offering in the network of devices (e.g., performed by the context-aware decision module 2130 of the network node 2100). The method 200 then comprises determining 204 that the one or more networking functionalities, upon deployment, at least partly fill the identified gap (e.g., performed by the context-aware decision module 2130 of the network node 2100 and/or the functionality module 2150). The method 200 then continues with deploying 206, at least temporarily, the one or more networking functionalities in the network (e.g., performed by the context-aware decision module 2130 and the functionality module 2150 and/or the network interface module 2170 of the network node 2100). The method 200 also comprises periodically assessing 208 relevance of maintaining deployment of the one or more networking functionalities in the network (e.g., performed by the context-aware decision module 2130 of the network node 2100). The method 200 then continues with, upon determination that the one or more networking functionalities are superfluous, at least temporarily decommissioning 210 the one or more functionalities.

The method 200 may optionally include negotiating the deployment with one or more of the devices therebefore. Skilled persons will readily recognize that t identifying the gap 202 may be performed in different manners. For instance, identifying the gap may be performed by receiving a request from one or more of the devices and/or by autonomously detecting deterioration of the telecommunication service offering at the network node. Likewise, periodically assessing may be performed using a timer and determination may be made that the one or more networking functionalities are superfluous upon expiry of the timer.

Although FIG. 2 shows example blocks of method 200, in some implementations, method 200 may include additional blocks, fewer blocks, different blocks, or differently arranged blocks than those depicted in FIG. 2. Additionally, or alternatively, two or more of the blocks of method 200 may be performed in parallel.

In the following description, an example of the network node 2200 being compatible with 5G is presented as being configured to form a robust integrated access backhaul network in order to create an optimal communication channel from terminal node to the core network. The stem-cell node network is operated with at least one IAB donor that terminates the backhaul link to connect to the 5G core. The network node 2100 functionalities are implemented by an IAB-node. As depicted in the example, a context-aware decision is made to provision (or activate) one or more networking functionalities of the IAB-node (e.g., based on the network condition, such as the number of hop-count that exceeds the threshold, IAB-donor failure, network congestion, etc.) As such, IAB-donor functions are activated into the IAB-node to make it be an IAB-donor. The IAB-node acting as a new IAB donor sets a timer. In some implementations, the IAB-node acting as the new IAB donor transmits admission requests to other IAB nodes. When IAB nodes receive the admission requests, a switching procedure to connect to the new IAB donor is made and a new cluster is formed. The switching decision may be implemented, for instance, by biasing the higher quality of services (QoS) in terms of hop-count, and available resources such bandwidth, radio resource blocks. A switching procedure may be operated in accordance with existing procedures (e.g., IAB switching mechanism presented in Release 16).

A decommissioning (or deactivation) procedure may be triggered when the network environment meets constraints such as low energy consumption, from a decision of a network administrator, from resource overallocation, etc. When networking functionalities of the new IAB-donor are decommissioned, the new IAB donor reverts back to a state of IAB-node, which may further be ready for reactivation. A switching IAB donor may be invoked for all IAB-nodes belonging to it. The best IAB-donor may then be selected to connect with the IAB-node. All these procedures may be compatible with standard IAB functions (e.g., presented in Release 16).

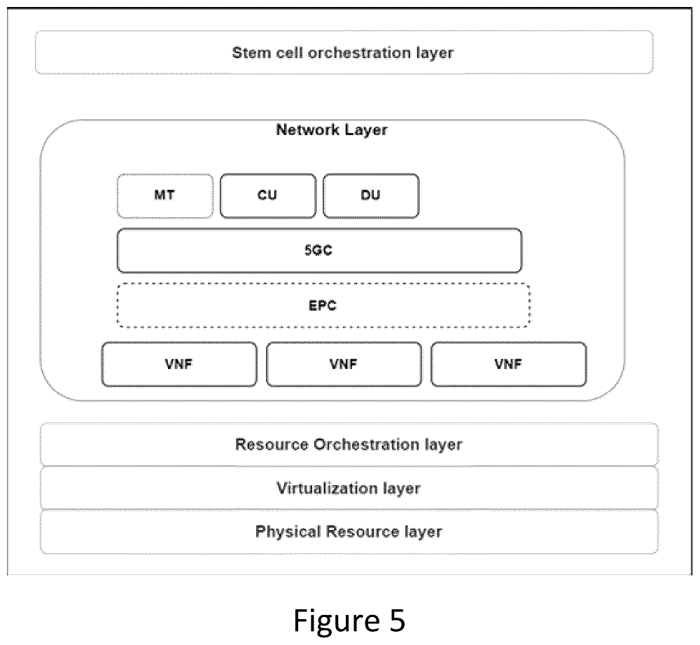

With reference to FIG. 5, different layers of a IAB-node compatible with the functionalities of the network node 2100 previously describe comprises multiple layers.

System Resource layer: includes network resources, radio resources, computing resources and storage resources.

Network layer; Dynamic RAN functions. CU: The CU (central unit) provides gNB functions. In a conventional IAB network, an IAB-donor is a base station that has a fiber (or wired) backhaul to the 5G core network and that further hosts a DU (distributed unit) and CU to handle the control and upper layers of the radio interfaces. CU has computing resources to be responsible for the IAB network topology, route management and resource allocation. The present disclosure allows the CU unit to be scheduled at each stem-cell node and to dynamically function a gNB in the network 2000. DU: The DU includes the Radio Link Control (RLC), Medium Access Control (MAC), and Physical layer (PHY) protocols. The IAB donor uses DU to serve user equipment devices (UEs) and serve the connected IAB nodes while the IAB nodes rely on DU functionalities to provide service for UEs or children IAB nodes. DU is the radio unit that exists in every stem-cell node. MT (mobile termination): The MTs act as UEs and associate with the DU of the parent IAB node or IAB donor. The MT unit in the present context is a dynamic function which is activated or deactivated depending on the role of each IAB node.

Stem cell orchestration layer; Intelligent layer: The intelligent layer represents the stem-cell node controller module (also referred to more generically as the context-ware decision module 2130) that provides control function (aka “the brain”) of the network 2000. The Stem cell orchestration layer is responsible for secondary functions such as network monitoring, synchronization, interface management, clustering, resource allocation and routing management. For example, due to the failure of an IAB-donor, a trigger procedure in the control layer will activate a CU unit and synchronize to other IAB nodes in order to serve as an IAB donor. The intelligent layer is an additional component where secondary functions are developed on top of it.

Virtualization layer; Virtual 5G Core functions: The present disclosure introduces a virtual 5G Core (v5GCore) function that allows network services be provisioned closer to the UEs. The v5GCore function involves the virtualization of the Evolved Packet Core (EPC) and the 5G Core using virtual network functions (VNF). Integrating v5GCore functions into stem-cell node enables a flexible and more efficient way to serve end-user services at stem-cell node s. v5GCore is an additional component in the stem-cell node where some nodes have available resources to run v5GCore functions to serve user requests.

Network functions of the 5G Core may be executed on top of each stem cell node as software (e.g., Based on the virtualization platform).

The stem-cell node (implementing functionalities of the network node 2100 previously introduced) may be a zero-touch function that may use network function virtualization (NFV) techniques, machine learning (ML), deep learning (DL), or artificial intelligence (AI) to coordinate and manage services, middleware, and complex systems. The stem-cell node may be described as an intelligent cellular node that enables self-network-monitoring and management to operate the backhaul network automatically. The characteristics of the stem-cell node may include: Autonomous RAN functions, Clustering, Traffic steering, Multi-RAT, Intelligent backhaul, Plug-and-play, Energy efficiency.

Autonomous RAN functions: Each stem-cell node could may be able to make a decision to activate/deactivate RAN elements (CU, DU and MT) according to the network conditions.

Clustering: A clustering mechanism may be deployed allowing different networking functionalities to be executed on less capable standalone nodes, which become, when clustered, capable of processing and storing greater needs/requests.

Traffic steering: Based on the functional split architecture of gNB, the stem-cell node network may enable traffic steering between different nodes. The traffic steering characteristic based on the CU/DU split is transparent to the UE, i.e., it does not impact UE functionality or protocol stack.

Multi-RAT: Multiple interfaces may equip the stem-cell node that may extend the backhaul links and may also connect to the core network. A dynamic interface switch and an optimal routing mechanism are introduced for enabling a dynamic and optimized way to interconnect the nodes, including wifi, LTE, PLC, COAX, etc.

Intelligent backhaul: The Intelligent backhaul may enable the placement of 5GCore closer to UEs. The stem-cell node's virtualization capabilities may be used to allow 5GCore functionality at network nodes, e.g., in order to fulfill specific user requirements. As such, it may be possible to improve the network's performance, e.g., in terms of coverage, latency, and bandwidth, which advantages could not be attained by utilizing the traditional network architecture.

Plug-and-play: the Plug-and-play stem-cell characteristic may take advantage of the multi-RAT within any network node. In such context relative to IAB, the constraint of backhaul links, which are mostly reliant on mmWave connections and the fiber connections from IAB donors to the core network, may be extended. Since the self-configuration function may autonomously make network decisions to operate the network 2000, it also reduces an IAB node's reliance on the IAB donor. Additionally, the clustering feature may enable certain nodes to function fully while having limited resource availability. In addition, compared to standard nodes, the stem-cell node may be become compact but highly powerful when combined with other functions which may further make it easier to deploy in the network 2000.

Energy efficiency: Since each stem-cell node has an intelligent layer to activate and deactivate some network functions in the stem-cell node, reduction in energy consumption of an stem-cell node may be achieved. Additionally, in some specific cases, such as when IAB (or any other type of network node) is powered by renewable energy, traffic steering and clustering features may enable an stem-cell node to operate at the lowest capacity with full functions while still saving energy.

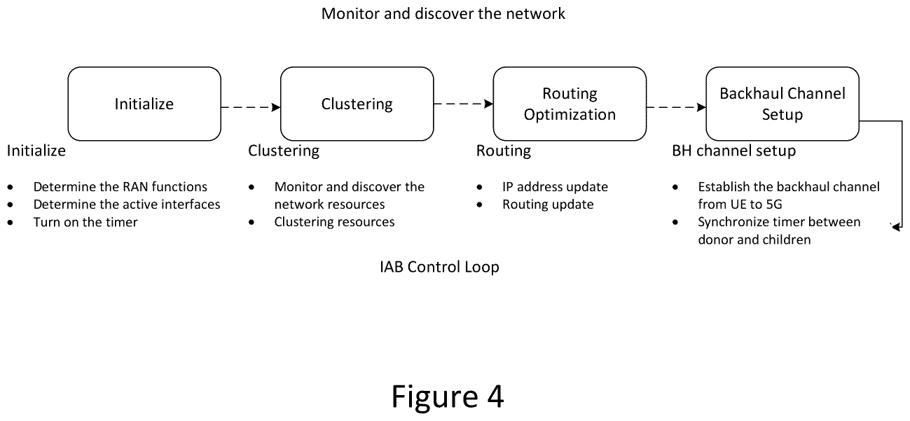

FIG. 4 depicts an example of an stem-cell node control loop. The stem-cell node may provide key building blocks for end-to-end, closed-loop, and automated control of the stem-cell node. When it is made to be compatible with the standard 3GPP, including 3GPP IAB network, it also represents a practical mechanism for embedding optimization and intelligence in the control of the stem-cell node. The exemplary workflow of the stem-cell node control loop depicted in FIG. 4 is as follows:

Step 1: Each stem-cell node is equipped with monitoring and discovering functions to observe the network condition. These functions will trigger a decision of controlling RAN functions (including CU and MT). They also trigger active interfaces to have the best connections to other nodes. A timer will be set for each RAN element which is used to synchronize the other RAN function in order to function a network node, such as gNB, to serve UEs.

Step 2: A clustering decision is announced from the initiating node, in here IAB donor, to other nodes in order to cluster the network based on the resource results collected by monitoring and discovering steps.

Step 3: After establishing a cluster, routing decisions are calculated to efficiently steer the traffic from last node, In here a child IAB, to the core.

Step 4: The backhaul channel is updated to operate the network, in here an IAB network, as the standard system. A synchronization is executed to keep all nodes, in here IAB nodes, functioning as a conventional network, in here an IAB network. Back to Step 1.

FIG. 5 depicts an example of overall “stack” architecture of an stem-cell node. While more emphasis may be perceived on describing the stem-cell node as enhancing functionalities of an IAB-donor, skilled persons will readily understand that the stem-cell node elements described herein may also apply to other serving or served node such as, for instance, GnB, Enb, IAB donor, IAB, or base station, etc.

All the elements of an stem-cell node may be built on the top of a virtualization platform where RAN functions (e.g., MT, DU, and CU), 5GCore and other network functions are virtualized based on VNFs. Unlike the traditional network, as illustrated by example here as IAB network, each stem-cell node may have the flexibility to operate independently or in conjunction with other nodes, herein IABs, to serve as an IAB-node, IAB-donor, or even 5GCore.

Network layer. Network functions are used to operate the stem-cell node's functions As a result, the stem-cell architecture offers a lot of room for expansion and development of ancillary features like resource optimization, routing, scheduling, etc.

Orchestration layer. Resource orchestration layer is to cluster resources in the network nodes, such as IAB network, to provide dynamically greater capacity network resources. This orchestration between nodes can provide an optimal resource allocation to operate the network in different network circumstances

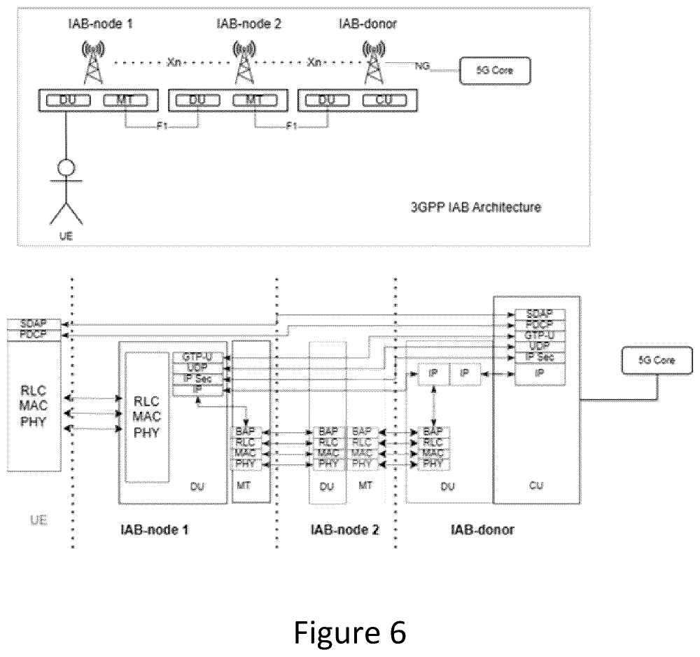

FIG. 6 shows an exemplary stem-cell node architecture and interfaces between network elements. Similar to the 3GPP IAB architecture, the stem-cell functionality comprises two network elements: an IAB-donor and an IAB-node, as well as an interface F1. Different from the conventional IAB defined in the 3GPP IAB architecture, each stem-cell node has RAN units including Centralized Unit (CU), Distributed Unit (DU), and Mobile Termination (MT). However, these RAN units are dynamically operated in a specific combination to function an IAB node in the network. As shown in the previous figures, the combination of CU, DU and MT creates different roles, e.g., the IAB connected with UE only activates DU and MT, and the middle IAB activates all elements, while the other IAB nodes have deactivated MT. The role of each IAB node is different from the view of each UE. For example, the middle IAB is considered as the parent IAB node in the connection of UE1 but it is the gNB in the connection of UE2.

Furthermore, the architecture of the stem-cell node illustrates the flexibility of backhaul links with Multi-RAT including inter-connection of IAB and IAB to the core network as well. This feature may increase the network performance in terms of the coverage ability, bandwidth and latency and may also enable flexibility of deployment in the IAB network.

In the depicted stem-cell node design, which differs from the traditional IAB, an intelligent layer is included in order to govern various RAN components and dynamic interfaces. The exemplary implementation places virtualized network functions on top of each IAB and makes use of an edge capability. Each element's lifetime (MT, DU, and CU) may be scheduled by the intelligent layer, which will also synchronize with all other nodes. The primary features constructed on top of the intelligent layer are optimal routing, clustering, scheduling, synchronization, and backhaul interfaces. The fundamental IAB functionalities mentioned in, e.g., Release 16 of the 3GPP may be provided, including switching IAB donors and creating connections from UEs to IAB donors.

The stem-cell node may employ a coordination ability to be aware of other base stations. A coordinated multi-base-station lets multiple base stations jointly operate to obtain spectral efficiency which improves the performance and may further provision additional network functionalities by transformation into the stem-cell node. Such a transformation is supported through the functional splits in 5G in Release 16 of the 3GPP, including switching IAB donors and creating connections from UEs to IAB donors.

The IAB protocol stack for user plane and control plane follows the 3GPP IAB architecture. The overall architecture is based on the functionality split. In particular, the DU includes the Radio Link Control (RLC), Medium Access Control (MAC), and Physical layer (PHY) protocols. The CU contains Service Data Adaptation Protocol (SDAP) or Radio Resource Control (RRC) protocol in the control plane or user plane, respectively, and Packet Data Convergence Protocol (PDCP). The interface between CU and DU is standardized as an F1 interface. The IAB donor employs non-IAB backhaul to connect to the core network while using wireless communication to serve the connected IAB nodes and UEs.

Mobile terminations (MTs) and DU functions are included in IAB nodes. The IAB nodes depend on IAB for backhauling and use the DU capabilities to serve both UEs and IAB nodes. The MTs function as typical devices and connect to the DU of the donor or parent IAB node. The link between the IAB node MT and its parent node DU provides lower layer functionality on which the message transmission is based.

IAB node can be backhauled to the IAB donor through more than one intermediate IAB node. The lower three protocols stack up to the RLC are known collectively as the NR-Uu interface. The middle three layers between Backhaul Adaptation Protocol (BAP) and PDCP provide the F1 interface for user plane (F1-U) and control plane (F1-C). Following 3GPP, the BAP is a novel protocol defined by IAB, and is responsible for routing information packets from IAB donor to the target IAB node and vice versa. A typical IAB node may have its own BAP address.

For downlink (DL) scenario, the BAP layer of IAB donor first adds the BAP header to the information packets. The BAP header comprises the routing ID for the destination BAP address, and the path ID includes the path to the destination node. A flag indicator included in the BAP header is determined by the packet type (e.g., control plane or user plane).

Once the typical IAB node receives an information packet, the BAP layer will first check the routing ID in the BAP header. If the IAB node is the destination node, the information packet will be forwarded to higher layers. The packet will be elevated to GTP-U or F1-AP, as illustrated in the figure, if it is targeted for a UE that the IAB node serves or if it is a control plane packet for the IAB node. If not, the IAB node will transfer the packet to the next node according to the routing table after delivering it to its DU. IAB allows multi-hop backhauling on either a unique, dedicated frequency or the same channels as user equipment (UE) access.

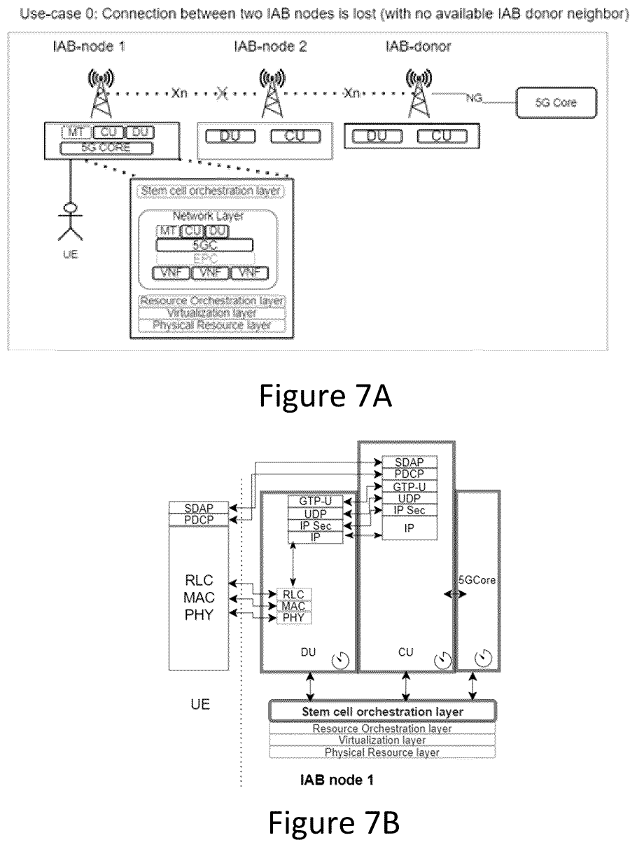

Use Case 0 (FIG. 7): Failure of the Link Between Two IAB Nodes (with No Available IAB-Donor Neighbor)

In some cases, the connection between IAB-node 1 and IAB-node 2 may be lost. Such a situation makes all the sessions from UEs to IAB-node1 fail if there are not any other available IAB-donors to connect with. In use-case 0 depicted in FIG. 7, a network node 2100 (aka stem cell node) can act as the IAB-donor and the core network by activating the following aspects: flexible CU/DU deployment, virtualization and intelligent backhaul. As shown in FIG. 7, the IAB network architecture is not changed. In particular, the IAB-node enabled by the network node 2100 will trigger to activate the Core modules (5G Core or/and EPC) and some secondary functions (e.g., caching, storage, offloading) by running networking functionalities. The network node 2100 will serve user requests locally without interruption. The MT module is deactivated. The lower protocol stack is not changed but all the processes to connect UE to the core network are operated locally.

### Procedure:

Step 1: Monitoring and discovering the network condition to recognize the link failure

Step 2: Determining to activate network functions: CU and 5G Core and deactivating MT function

Step 3: Performing the default procedure for UE Initial access.

A. The UE sends an RRCSetupRequest message to the DU.

B. The DU includes the RRC message and, if the UE is admitted, the corresponding low layer configuration for the UE in the INITIAL UL RRC MESSAGE TRANSFER message and transfers to the CU. The INITIAL UL RRC MESSAGE TRANSFER message includes the C-RNTI allocated by the DU. If the DU identifies the UE as a Reduced Capability UE during the random access procedure, a NR RedCap UE Indication is provided in the INITIAL UL RRC MESSAGE TRANSFER message.

C. The CU allocates a CU-UE-F1AP-ID for the UE and generates a RRCSetup message towards UE. The RRC message is encapsulated in—the DL RRC MESSAGE TRANSFER message.

D. The DU sends the RRCSetup message to the UE.

E. The UE sends the RRC CONNECTION SETUP COMPLETE message to the DU.

F. The DU encapsulates the RRC message in the UL RRC MESSAGE TRANSFER message and sends it to the CU.

G. The CU sends the INITIAL UE MESSAGE message to the 5G CORE (AMF function).

H. The 5G CORE sends the INITIAL CONTEXT SETUP REQUEST message to the CU.

I. The CU sends the UE CONTEXT SETUP REQUEST message to establish the UE context in the DU. In this message, it may also encapsulate the SecurityModeCommand message. In case of NG-RAN sharing, the CU includes the serving PLMN ID (for SNPNs the serving SNPN ID).

J. The DU sends the SecurityModeCommand message to the UE.

K. The DU sends the UE CONTEXT SETUP RESPONSE message to the CU.

L. The UE responds with the SecurityModeComplete message.

M. The DU encapsulates the RRC message in the UL RRC MESSAGE TRANSFER message and sends it to the CU.

N. The CU generates the RRCReconfiguration message and encapsulates it in the DL RRC MESSAGE TRANSFER message.

O. The DU sends RRCReconfiguration message to the UE.

P. The UE sends RRCReconfigurationComplete message to the DU.

Q. The DU encapsulates the RRC message in the UL RRC MESSAGE TRANSFER message and send it to the CU.

R. The CU sends the INITIAL CONTEXT SETUP RESPONSE message to the 5G CORE

Step 4: Setting timer for the activation functions: CU and 5G Core.

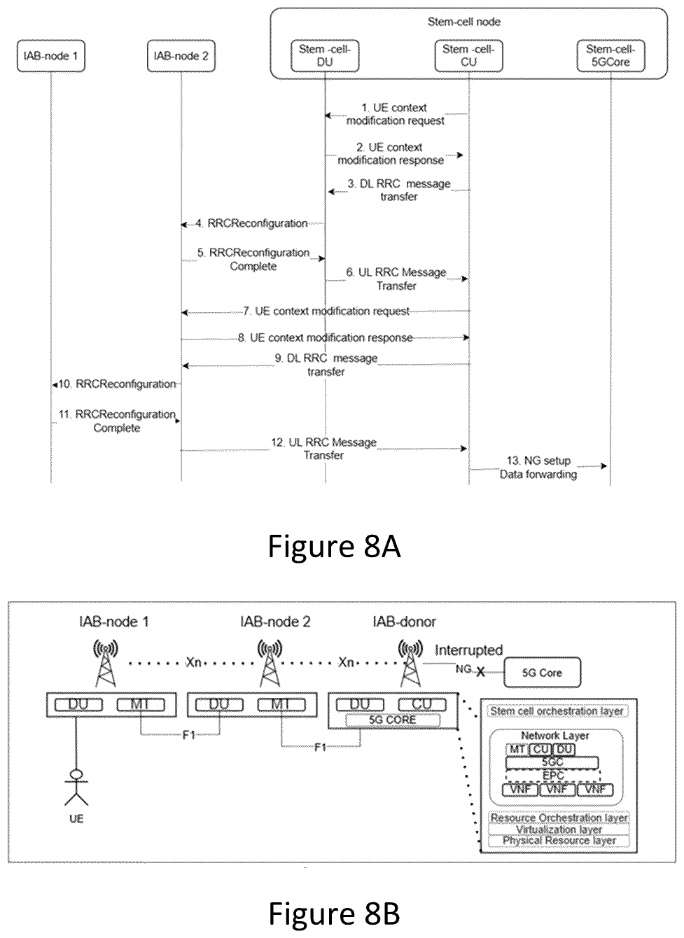

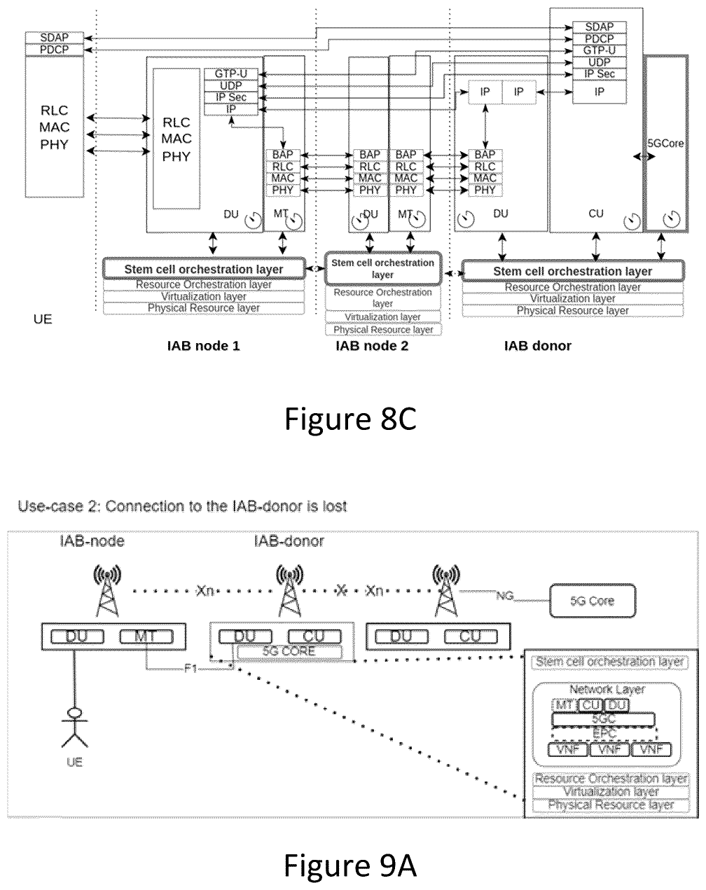

### Use Case 1 (FIG. 8): Failure of the Link to the Core-Network

In some cases, the connection to the core network may be lost because of network failure or outage. In use-case 1 depicted in FIG. 8, a network node 2100 (aka stem cell node) can replace the IAB-donor by activating the following aspects: flexible CU/DU deployment, virtualization and intelligent backhaul. As shown in the figure, the stem-cell network architecture is not changed except the virtual network functions of the IAB donor. In particular, the stem-cell node which is enabled by the network node 2100 will trigger to activate the Core modules (5G Core and EPC) and some secondary functions (e.g., caching, storage, offloading) by running network functions. The network node 2100 will serve user requests locally without interruption. The MT module is still deactivated.

The lower protocol stack is not changed except the backhaul link from CU to the core network that is eliminated since the 5G Core is deployed locally.

Similar to the standard IAB system, the BAP layer of the IAB donor first adds the BAP header to the information packets. The BAP header comprises the routing ID for the destination BAP address, and the path ID includes the path to the destination node. A flag indicator included in the BAP header is determined by the packet type (i.e., control plane or user plane).

Once the typical IAB node receives an information packet, the BAP layer will first check the routing ID in the BAP header. If the IAB node is the destination node, the information packet will be forwarded to higher layers. The packet will be elevated to GTP-U or F1-AP, as illustrated in the figure, if it is targeted for a UE that the IAB node serves or if it is a control plane packet for the IAB node. If not, the IAB node will transfer the packet to the next node according to the routing table after delivering it to its DU.

Since the IAB-donor facilitates the 5G Core function, the UE communicates to the 5GC over the relaying path for both its control- and user plane messages terminate at the IAB-donor.

### Procedure:

Step 1: Monitoring and discovering the network condition to recognize the link failure

Step 2: Determining to activate network functions: CU and 5G Core and deactivating MT function.

Step 3: Establish the connection from UE to the Core network (which is placed locally). The signaling flow for IAB BH RLC channel establishment procedure may be as follows.

a. The IAB-donor-CU sends to the IAB-donor-DU a UE CONTEXT MODIFICATION REQUEST message for setting up the parent-node IAB-DU side of the BH link between IAB-donor-DU and IAB-node 2.

b. The IAB-donor-DU sends the UE CONTEXT MODIFICATION RESPONSE message to the IAB-donor-CU.

c. The IAB-donor-CU sends to the IAB-donor-DU a DL RRC MESSAGE TRANSFER message encapsulating the RRCReconfiguration message for configuring the IAB-MT of IAB-node 2.

d. The IAB-donor-DU decapsulates and forwards the RRCReconfiguration message to the IAB-MT of IAB-node 2.

e. The IAB-MT of IAB-node 2 sends to the IAB-donor-DU an RRCReconfigurationComplete message destined to the IAB-donor-CU.

f. The IAB-donor-DU sends the UL RRC MESSAGE TRANSFER message encapsulating the RRCReconfigurationComplete message to the IAB-donor-CU.

g. The IAB-donor-CU sends to the IAB-DU of IAB-node 2 a UE CONTEXT MODIFICATION REQUEST message for setting up the parent node IAB-DU side of the BH link between IAB-node 1 and IAB-node 2.

h. The IAB-node 2 sends the UE CONTEXT MODIFICATION RESPONSE message to the IAB-donor-CU.

i. The IAB-donor-CU sends to the IAB-DU of IAB-node 2 a DL RRC MESSAGE TRANSFER message encapsulating the RRCReconfiguration message for configuring the IAB-MT of IAB-node 1.

j. The IAB-DU of IAB-node 2 decapsulates and forwards the RRCReconfiguration message to the IAB-MT of IAB-node 1.

k. The IAB-MT of IAB-node 1 sends to IAB-node 2 an RRCReconfigurationComplete message destined to the IAB-donor-CU.

I. IAB-node 2 sends the UL RRC MESSAGE TRANSFER message encapsulating the RRCReconfigurationComplete message to the IAB-donor-CU.

m. The IAB-donor-CU uses the existing CU-DU split principles and the UE Context Setup procedure or UE Context Modification procedure to configure the parent IAB-DU side of the BH RLC channel. The IAB-donor-CU uses RRC signaling (which is encapsulated in the DL RRC MESSAGE TRANSFER message terminating at the parent node IAB-DU side of the BH RLC channel) to configure the child node IAB-MT side of the BH RLC channel.

n. The IAB-donor-CU configures the IAB-DU with a mapping to the BH RLC channel to be used for a specific UL F1-U tunnel during the UE Context Setup procedure or the F1-AP UE Context Modification procedure for the UE.

o. The IAB-UE can establish a connection to 5GC over NR via IAB-donor-CU

Step 4: Setting timer for the activation functions: CU and 5G Core (refer to the duration in ms that is used to control the resource blocks).

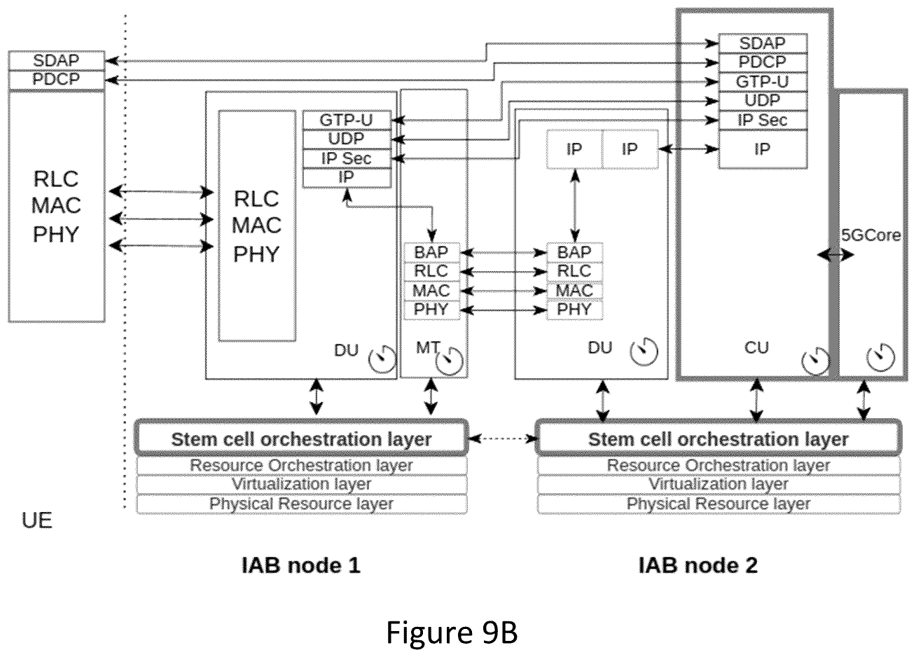

### Use Case 2 (FIG. 9): Failure of the Link to the IAB Donor

In some cases, the connection to the IAB donor may be lost because of network failure or outage. The stem-cell node enabled by the network node 2100 will trigger to activate the CU and 5G Core modules and some secondary functions (e.g., caching, storage, offloading) by running network functions. The node will serve user requests locally without interruption. The MT module is still deactivated. The use-case 2 depicted on FIG. 9 may be applied similarly to the EPC module.

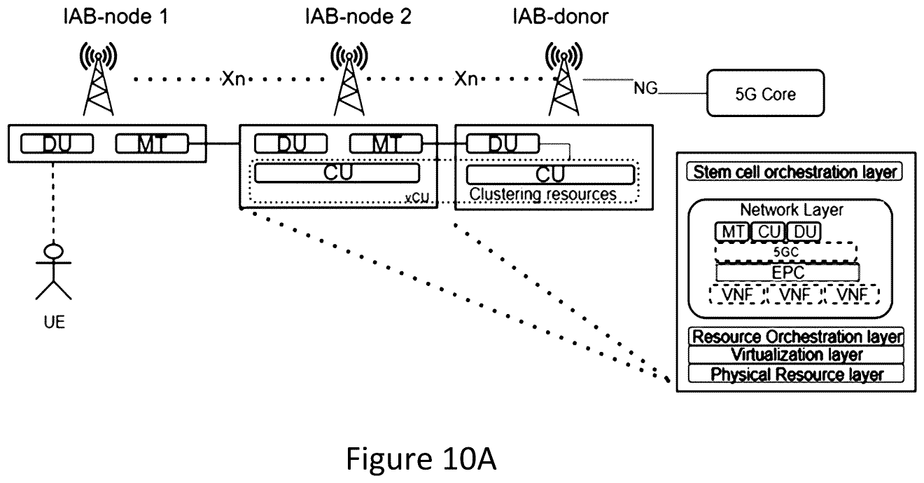

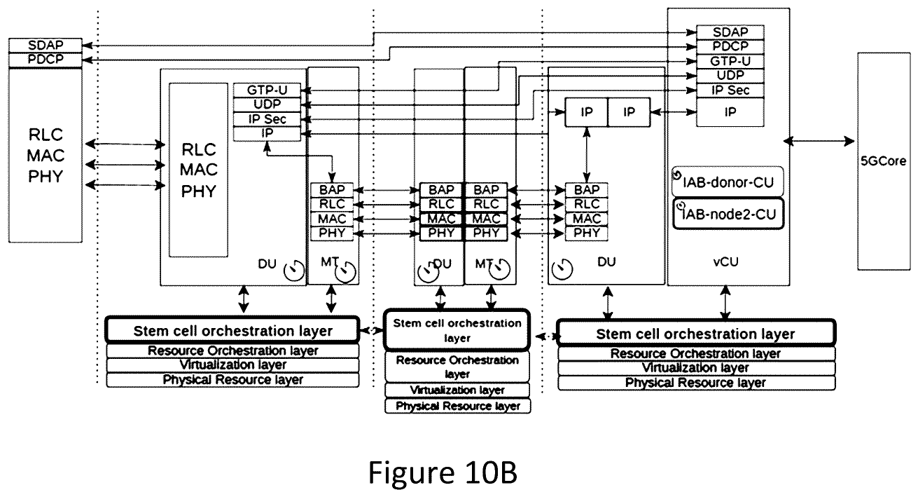

### Use Case 3 (FIG. 10): Lack of Resources at the IAB-Donor Node

In some cases, because of the peak traffic from UE, the IAB-donor may be unable to satisfy demands, e.g., in terms of resource availability. A clustering process may be activated to cluster the distributed computing resources from other nodes. In Use-case 3 depicted on FIG. 10, the CU of the middle IAB-node is activated to collaborate with the current donor in order to establish a greater CU to function as a gNB in the network.

In accordance with the 5G standard, the connection between CU and DU is based on the F1 interface. To make sure the vCU and DU that can function As a gNBit is assumed, for the purpose of illustration, that all the CUs are member of one cluster having F1 connections to the IAB-donor-DU that satisfy the KPI thereof.

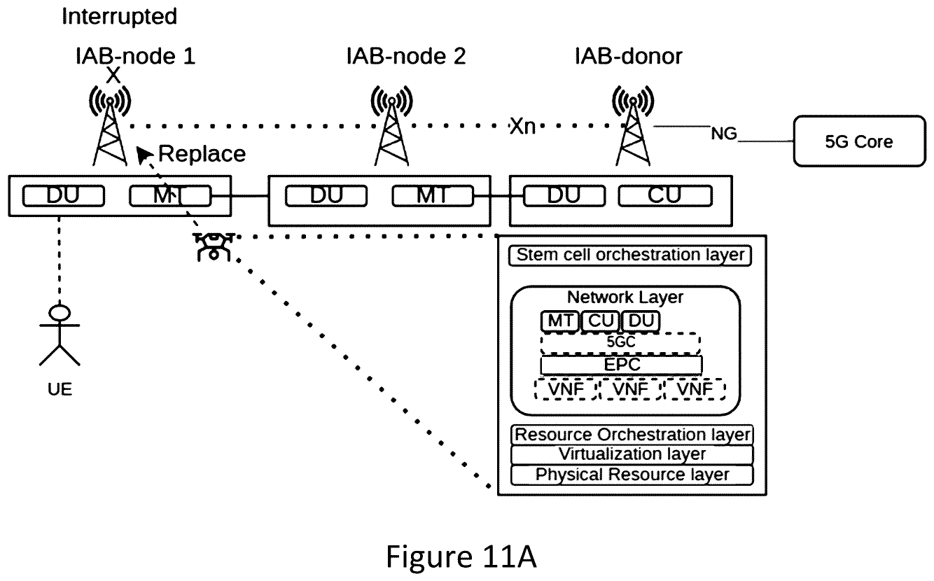

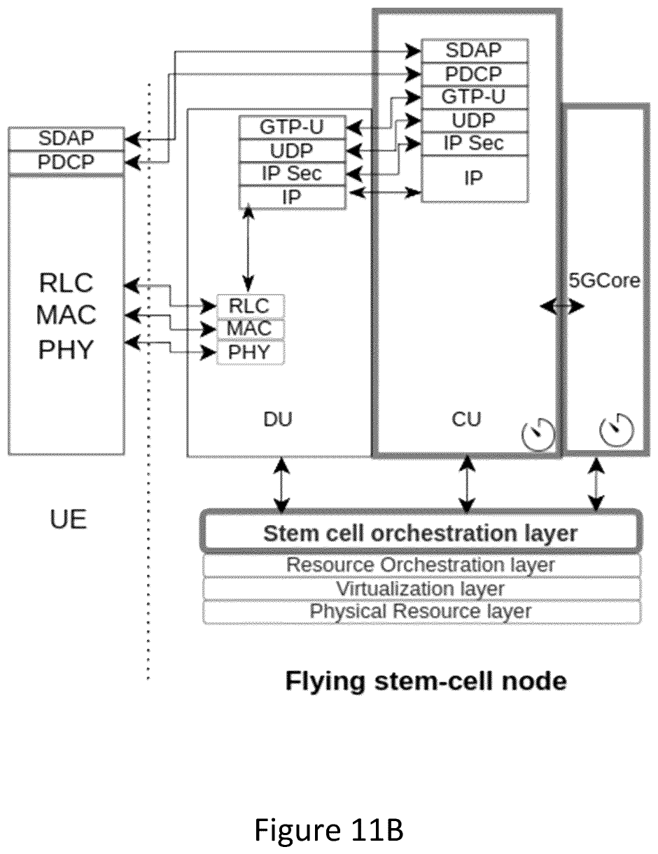

### Use Case 4 (FIG. 11): Flying Stem-Cell Node

In some cases, network failure happens at an IAB node in a specific area. For the purpose of fulfilling user demands in that region, a flying base station may be operated for deployment (e.g., for a temporary period). In FIG. 11, a UAV with CU, DU, and 5G Core functionalities is depicted. The process is similar to the use case 1 (FIG. 8).

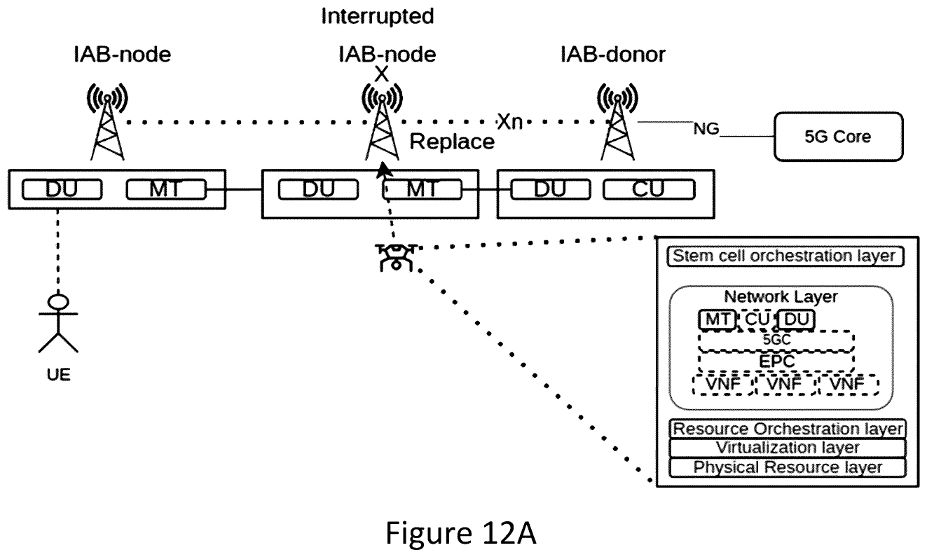

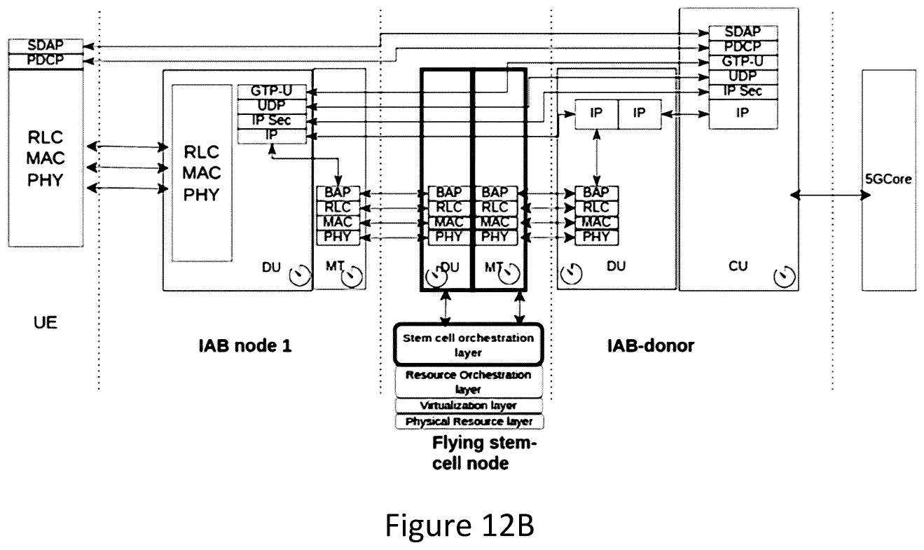

### Use Case 5 (FIG. 12): Flying Base Station for the Failure of a Parent Node (Single UAV)

In some cases, network failure happens at an IAB node (parent node) in a specific area. For the purpose of ensuring the continuity of the IAB network, a flying base station may be operated for deployment (e.g., for a temporary period). In this illustration, a UAV with MT, and DU functionalities is employed.

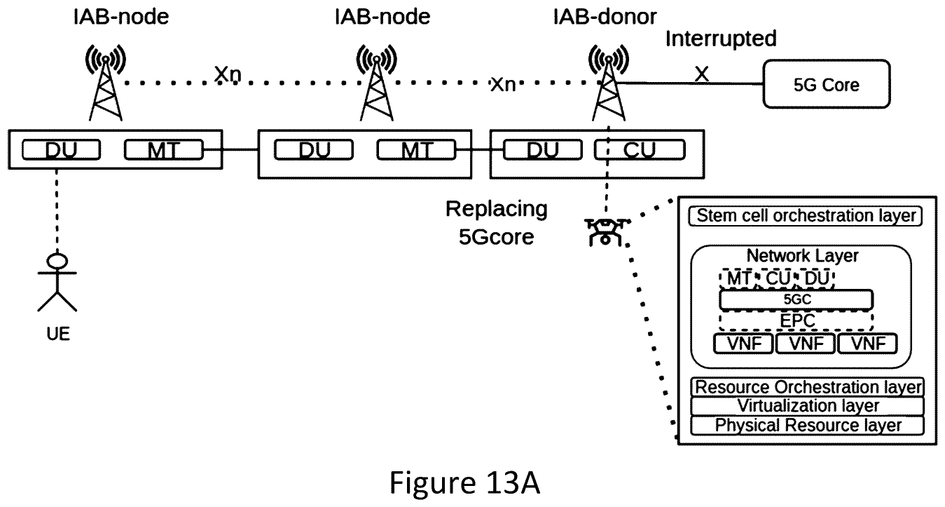

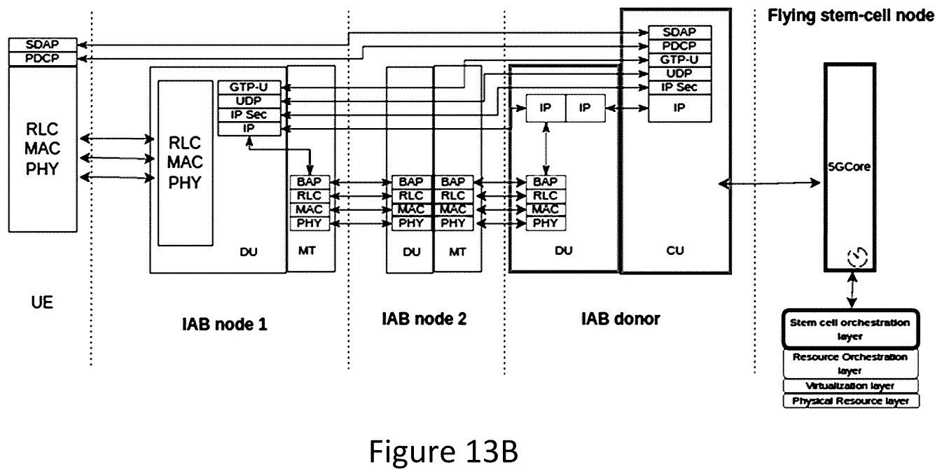

### Use Case 6 (FIG. 13): Flying Base Station for the Failure of an IAB-Donor (Single UAV)

In some cases, network failure happens at an IAB donor. For the purpose of ensuring the continuity of the IAB network, a flying base station may be operated for deployment (e.g., for a temporary period). In this illustration, a UAV with MT, DU, CU and 5GCore functionalities is employed. The process is similar to the use case 1 (FIG. 8).

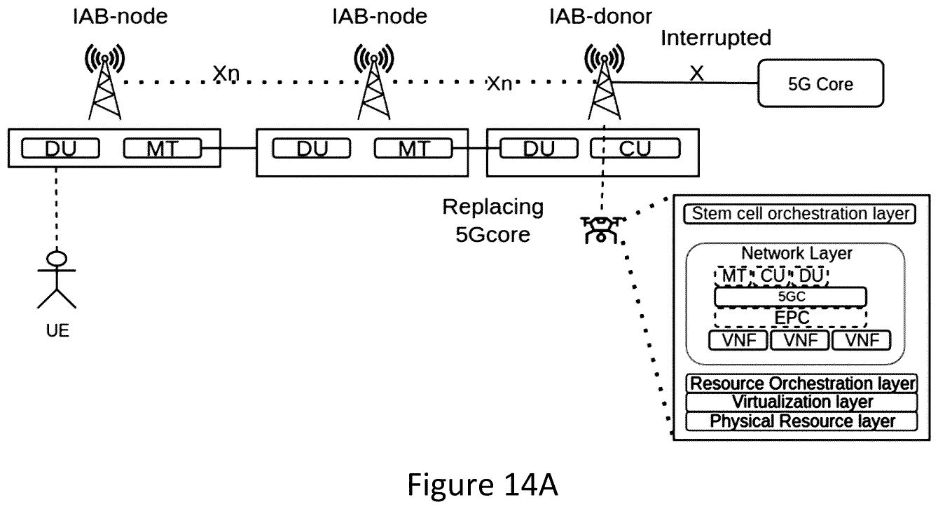

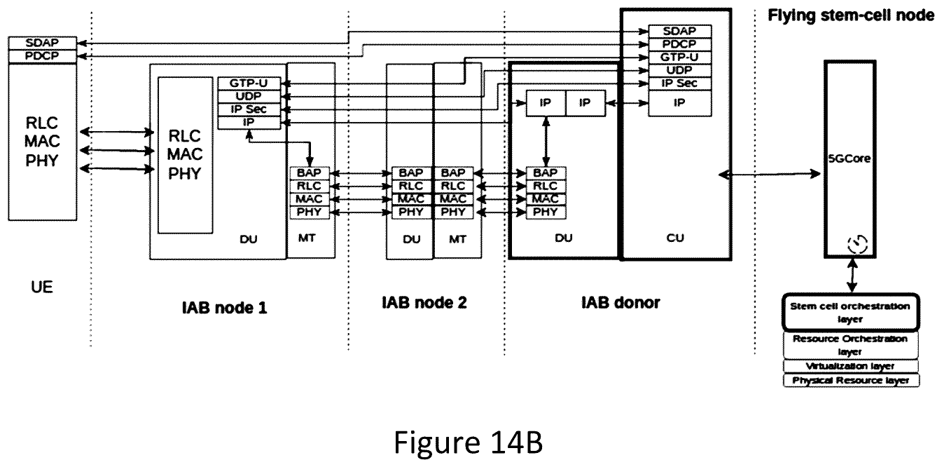

### Use Case 7 (FIG. 14): Flying Base Station for the Failure of the Core Network (Single UAV)

In some cases, network failure happens at a connection between an IAB donor and 5GCore. For the purpose of ensuring the continuity of the IAB network, a flying base station may be operated for deployment (e.g., for a temporary period). In this illustration, a UAV with MT, DU, CU and 5GCore functionalities is employed. The process is similar to the use case 1 (FIG. 8).

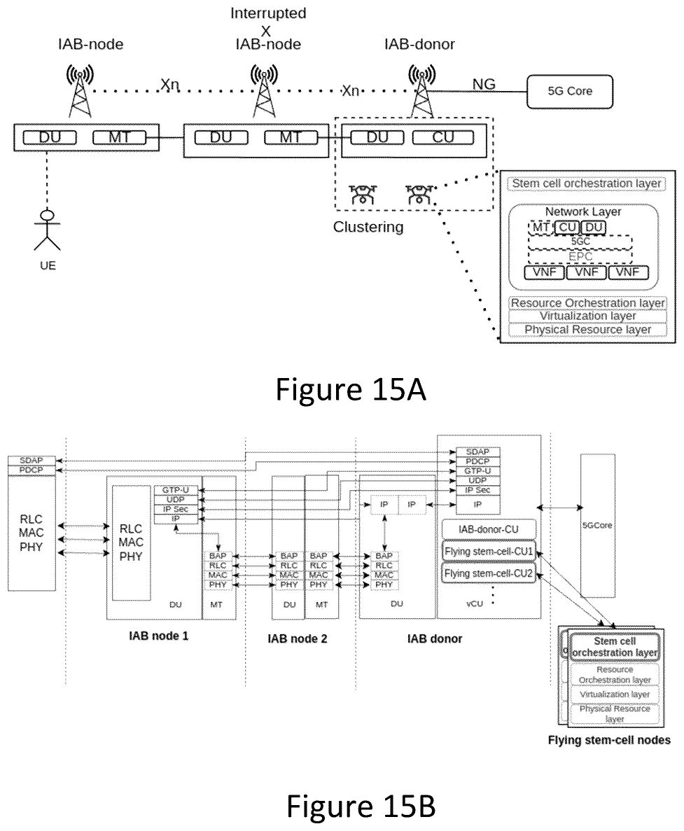

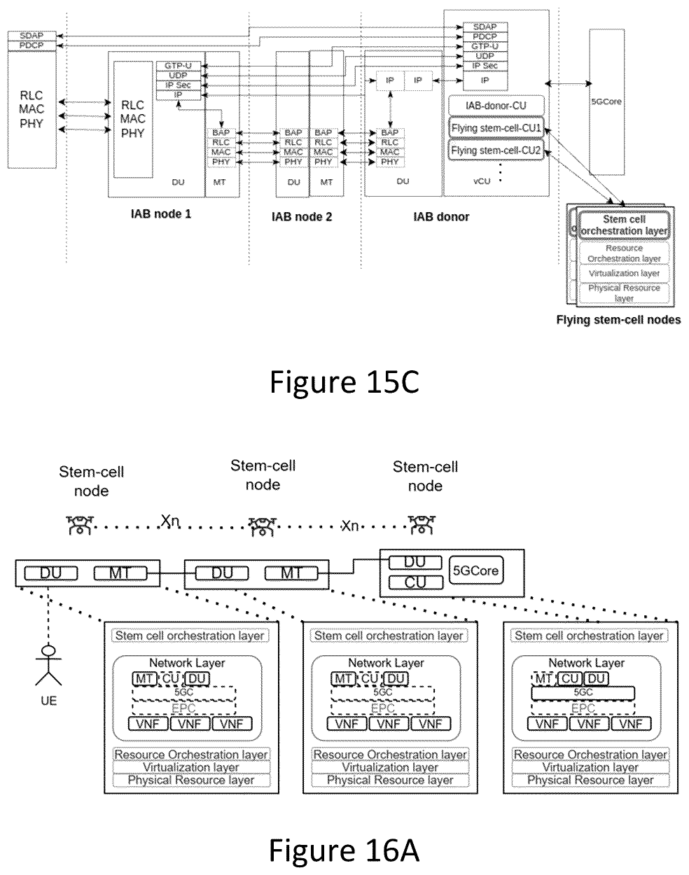

### Use Case 8 (FIG. 15): Flying Base Stations for Clustering Resources (Multiple UAVs)

In some cases, because of a peak of traffic from UEs, the IAB-donor may not be able to satisfy the user demand in terms of resource availability. A group of UAVs employing stem-cell functions may be deployed. A clustering process may be activated to cluster the ground and flying computing resources to enable a larger processing capability for serving user requests. The procedure is operated similar to the use-case 3 (FIG. 10).

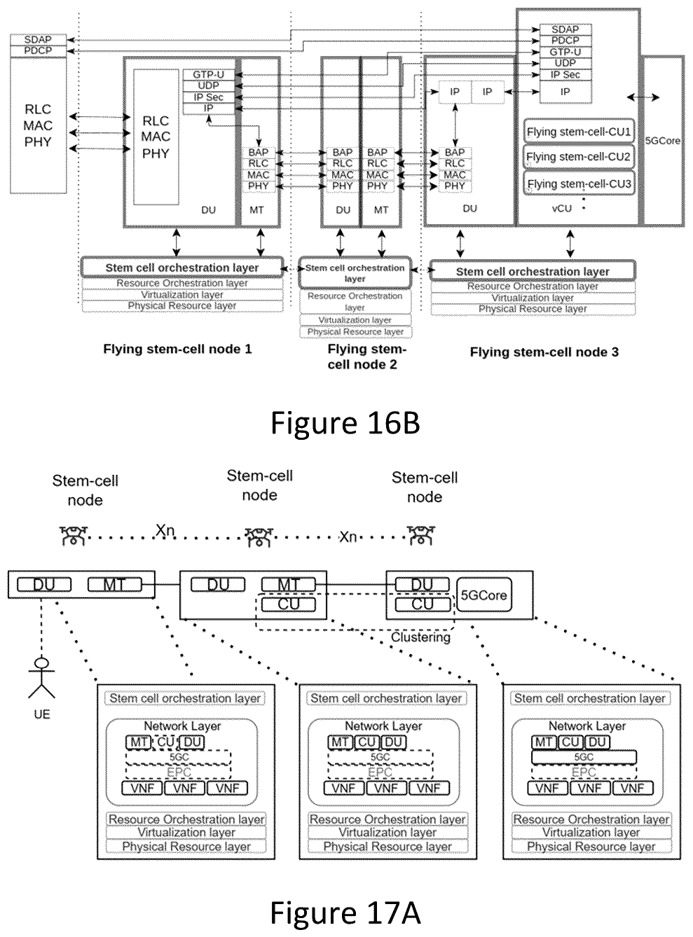

### Use Case 9 (FIG. 16): Multi-Flying Base Stations for a Self-Operation Network.

In some cases (e.g., disaster, special events), a terrestrial network may not be able to satisfy the user requests and a group of UAVs employing stem-cell functions may be deployed (e.g., for a temporary period). The deployed UAVs may automatically coordinate and operate as an IAB network where a cluster head will function as an IAB-donor and 5GCore while others function as IAB nodes. Without connections to the core network, these UAVs automatically operate and serve UEs. The procedure is similar to the use case 1 where the cluster head will activate CU and 5GCore functions.

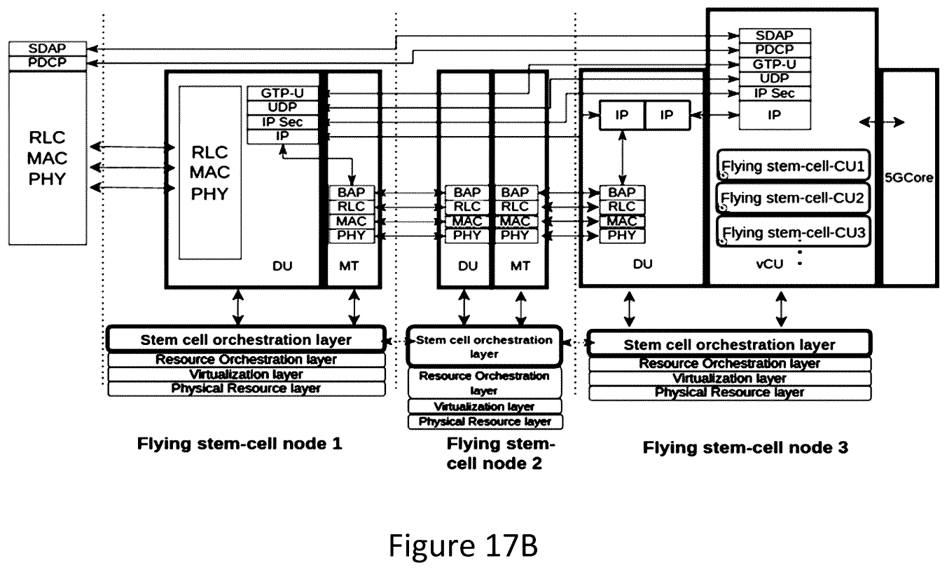

Use Case 10 (FIG. 17): Multi-Flying Base Stations for a Cluster Self-Operation network.

As an extension of the use-case 9 (FIG. 16), a group of UAVs employing stem-cell functions may be deployed and may automatically coordinate, operate and cluster as an IAB network where a cluster head will function as an IAB-donor and 5GCore while others function as IAB nodes. These UAVs may only carry a small payload (e.g., a small processing unit) but may be able to cluster to form a greater CU which can satisfy user demands. Without connections to the core network, these UAVs automatically operate and serve UEs. The procedure is similar to the use case 1 (FIG. 8) where the cluster head will activate CU and 5GCore functions.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method executed at a network node, in a network of devices, for providing one or more networking functionalities on the fly, the method comprising:
identifying a gap in telecommunications service offering in the network of devices;
determining that the one or more networking functionalities, upon deployment, at least partly fill the identified gap;
deploying, at least temporarily, the one or more networking functionalities in the network;
periodically assessing relevance of maintaining deployment of the one or more networking functionalities in the network; and
upon determination that the one or more networking functionalities are superfluous, at least temporarily decommissioning the one or more functionalities.

2. The method of claim 1, further comprising negotiating the deployment with one or more of the devices therebefore.

3. The method of claim 1, wherein identifying the gap is performed by receiving a request from one or more of the devices.

4. The method of claim 1, wherein identifying the gap is performed by autonomously detecting deterioration of the telecommunication service offering at the network node.

5. The method of claim 1, wherein periodically assessing is performed using a timer and wherein determination is made that the one or more networking functionalities are superfluous upon expiry of the timer.

6. A network node comprising:
one or more processors configured to:
identify a gap in telecommunications service offering in the network of devices;
determine that the one or more networking functionalities, upon deployment, at least partly fill the identified gap;
deploy, at least temporarily, the one or more networking functionalities in the network;
periodically assess relevance of maintaining deployment of the one or more networking functionalities in the network; and
upon determination that the one or more network functionalities are superfluous, at least temporarily decommission the one or more functionalities.

7. The network node of claim 6, wherein the one or more processors are configured to negotiate the deployment with one or more of the devices therebefore.

8. The network node of claim 6, wherein identifying the gap is performed by the one or more processors are configured to receive a request from one or more of the devices.

9. The network node of claim 6, wherein identifying the gap is performed by the one or more processors are configured to autonomously detect deterioration of the telecommunication service offering at the network node.

10. The network node of claim 6, wherein periodically assessing is performed by the one or more processors are configured to using a timer and wherein determination is made that the one or more networking functionalities are superfluous upon expiry of the timer.

11. A system comprising:
a network;
a plurality of devices in the network, wherein one or more of the devices comprise one or more processors configured to:
identify a gap in telecommunications service offering in the network of devices;
determine that the one or more networking functionalities, upon deployment, at least partly fill the identified gap;
deploy, at least temporarily, the one or more networking functionalities in the network;
periodically assess relevance of maintaining deployment of the one or more networking functionalities in the network; and
upon determination that the one or more network functionalities are superfluous, at least temporarily decommission the one or more functionalities.

12. The system of claim 11, wherein the one or more processors are further configured to:
negotiate the deployment with one or more of the devices therebefore.

13. The system of claim 11, wherein identifying the gap is performed by the one or more processors configured to receive a request from one or more of the devices.

14. The system of claim 11, wherein identifying the gap is performed by the one or more processors configured to autonomously detect deterioration of the telecommunication service offering at the network node.

15. The system of claim 11, wherein periodically assessing is performed by the one or more processors configured to use a timer and wherein determination is made that the one or more networking functionalities are superfluous upon expiry of the timer.
